(19) United States
(12) Patent Application Publication
(10) Pub. No.: US 2014/0098263 A1
(43) Pub. Date: Apr. 10, 2014

(54) IMAGE PROCESSING APPARATUS AND IMAGE PROCESSING METHOD

(71) Applicant: KABUSHIKI KAISHA TOSHIBA, Tokyo (JP)

(72) Inventors: Kyoka KOBUNA, Tokyo (JP); Toshiyuki ONO, Kawasaki-shi (JP); Yasunori TAGUCHI, Kawasaki-shi (JP); Toshimitsu KANEKO, Kawasaki-shi (JP); Nobuyuki MATSUMOTO, Inagi-shi (JP)

(73) Assignee: KABUSHIKI KAISHA TOSHIBA, Tokyo (JP)

(21) Appl. No.: 14/049,369

(22) Filed: Oct. 9, 2013

(30) Foreign Application Priority Data
Oct. 9, 2012 (JP) 2012-224385

(51) Int. Cl. H04N 5/235

(52) U.S. Cl. CPC H04N 5/2351
USPC 348/234

(57) ABSTRACT

According to an embodiment, an image processing apparatus includes a scattered light acquisition unit, a control information acquisition unit and a control unit. The scattered light acquisition unit acquires an amount of scattered light included in each pixel of an input image. The control information acquisition unit acquires control information determining an amount of scattered light included in each pixel of an output image. The control unit generates the output image by controlling the amount of the scattered light included in each pixel of the input image based on the control information.

### CROSS-REFERENCE TO RELATED APPLICATIONS

This application is based upon and claims the benefit of priority from Japanese Patent Application No. 2012-224385, filed Oct. 9, 2012, the entire contents of which are incorporated herein by reference.

### FIELD

Embodiments described herein relate generally to a technique for controlling the amount of scattered light in an image.

### BACKGROUND

When an image of an object is captured by means of a camera, light reflected from the object is attenuated and scattered by the atmosphere before reaching the camera. The light reaching the camera contains a mixture of the reflected light component from the object and a scattered light component that is ambient light scattered by the atmosphere. The scattered light component may blur the image. Removing the scattered light component from the image (that is, deblurring the image) allows the reflected light component from the object to be faithfully restored. Thus, the clarity of the image can be improved. However, the color of the scattered light in the image must be estimated in order to remove the scattered light component.

To complicate matters, someone viewing the image recognizes the object rendered in the form of pixels as being far away when the ratio of scattered light in the pixels is high, and being close when the ratio is low. Because of this, image processing that uniformly removes the scattered light component may degrade the depth feel of the image.

### BRIEF DESCRIPTION OF THE DRAWINGS

FIG. 1 is a block diagram illustrating an image processing apparatus according to the first embodiment.

FIG. 2 is a flowchart illustrating image processing by the image processing apparatus shown in FIG. 1.

FIG. 3 is a block diagram illustrating a scattered light acquisition unit shown in FIG. 1.

FIG. 4 is a flowchart illustrating scattered light acquisition processing by the scattered light acquisition unit shown in FIG. 3.

FIG. 5 is a flowchart illustrating details of step S101-2 shown in FIG. 4.

FIG. 6 is a flowchart illustrating details of step S102 shown in FIG. 2.

FIG. 7 illustrates a graphical user interface (GUI) displayed in step S102 of FIG. 2.

FIG. 8 is a block diagram illustrating an image processing apparatus according to the second embodiment.

FIG. 9 is a flowchart illustrating image processing by the image processing apparatus shown in FIG. 8

FIG. 10 is a flowchart illustrating details of step S201 shown in FIG. 9.

FIG. 11 illustrates a GUI displayed in step S201 of FIG. 9.

FIG. 12 explains a control information map.

FIG. 13 is a block diagram illustrating an image processing apparatus according to the third embodiment.

FIG. 14 is a block diagram illustrating a modification of FIG. 13.

FIG. 15 is a flowchart illustrating image processing by the image processing apparatus shown in FIG. 13.

FIG. 16 is a flowchart illustrating details of step S301 shown in FIG. 15.

FIG. 17 is a flowchart illustrating details of step S302 shown in FIG. 15.

FIG. 18 illustrates a GUI displayed in step S302 of FIG. 15.

FIG. 19 illustrates a GUI displayed in step S302 of FIG. 15.

FIG. 20 illustrates a GUI displayed in step S302 of FIG. 15.

FIG. 21 is a flowchart illustrating a modification of FIG. 17.

FIG. 22 illustrates a modification of FIG. 18.

FIG. 23 illustrates a modification of FIG. 19.

FIG. 24 illustrates a modification of FIG. 20.

FIG. 25 illustrates a GUI usable to designate a borderline between areas in step S201 of FIG. 9.

FIG. 26 illustrates a modification of FIG. 25.

FIG. 27 illustrates a general-purpose computer.

### DETAILED DESCRIPTION

In the following, the embodiments will be described in detail with reference to the drawings.

According to an embodiment, an image processing apparatus includes a scattered light acquisition unit, a control information acquisition unit and a control unit. The scattered light acquisition unit acquires an amount of scattered light included in each pixel of an input image. The control information acquisition unit acquires control information determining an amount of scattered light included in each pixel of an output image. The control unit generates the output image by controlling the amount of the scattered light included in each pixel of the input image based on the control information.

Components which are the same as or similar to described components are denoted by the same or similar reference numerals, and duplicate descriptions are basically omitted.

A color space is hereinafter assumed to be an RGB space unless another definition is given. However, since it is generally possible to change a certain type of color space to the other type of color space, a color space different from the RGB space may be applied instead of the RGB space. Further, the color of scattered light may be indicated as scattered light.

### First Embodiment

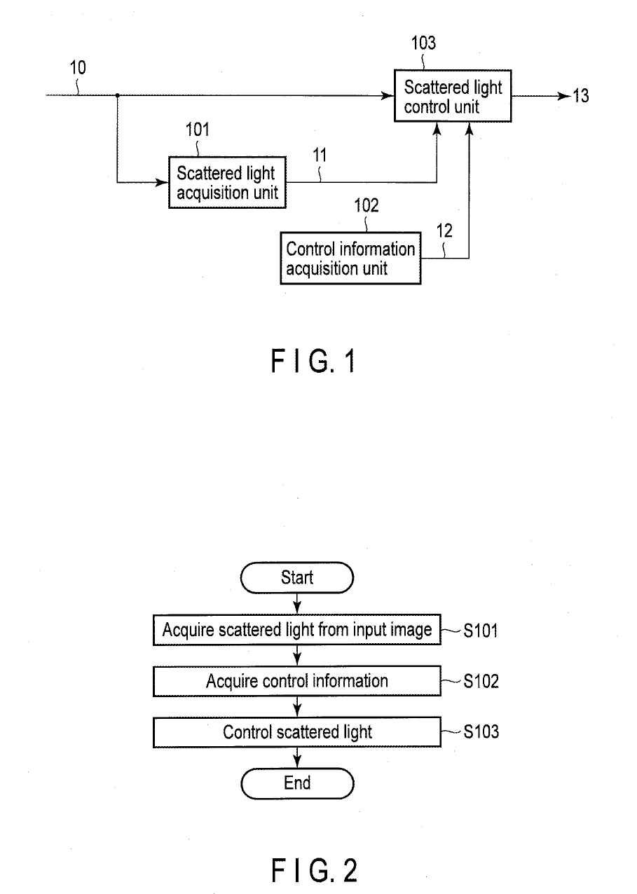

As illustrated in FIG. 1, an image processing apparatus according to the first embodiment comprises a scattered light acquisition unit 101, a control information acquisition unit 102 and a scattered light control unit 103. The image processing apparatus shown in FIG. 1 generates an output image 13 by controlling the amount of scattered light 11 included in each pixel of an input image 10 based on control information 12.

The scattered light acquisition unit 101 receives the input image 10 and acquires the scattered light 11 included in each pixel of the input image 10. The technique for acquiring the scattered light 11 will be described below in detail. The scattered light acquisition unit 101 outputs information on the scattered light 11 to the scattered light control unit 103. The scattered light is the color of light generated when sunlight, light reflected from an object or the like is scattered by particles in the atmosphere. The scattered light 11 is typically the color of haze or fog.

Each pixel of the input image 10 has the color in which light reflected from an object and scattered light are mixed. Generally, the ratio of scattered light in the pixels will be higher as the distance between an object and a view point (for example, a camera) becomes greater, and be lower as the distance between an object and a view point becomes smaller.

The scattered light 11 is generated not only in the atmosphere but also in the water. Accordingly, since the ratio of scattered light in the pixels will be higher as the distance between an object and a view point becomes greater for the input image 10 captured in the water, the color of pixels representing the object will be a color close to that of the scattered light (for example, blue).

The control information acquisition unit 102 acquire control information 12. The control information acquisition unit 102 typically displays a graphical user interface (GUI) described below on a display device not shown in the figures, acquires user input through the GUI, and acquires the control information 12 based on the user input. The control information acquisition unit 102 outputs the control information 12 to the scattered light control unit 103.

The scattered light control unit 103 receives the input image 10, inputs information of the scattered light 11 included in each pixel of the input image 10 from the scattered light acquisition unit 101, and inputs the control information 12 from the control information acquisition unit 102. The scattered light control unit 103 controls the amount of the scattered light 11 included in each pixel of the input image 10 based on the control information 12 to generate the output image 13. The scattered light control unit 103 supplies the output image 13 to a subsequent processing unit or device not shown in the figures.

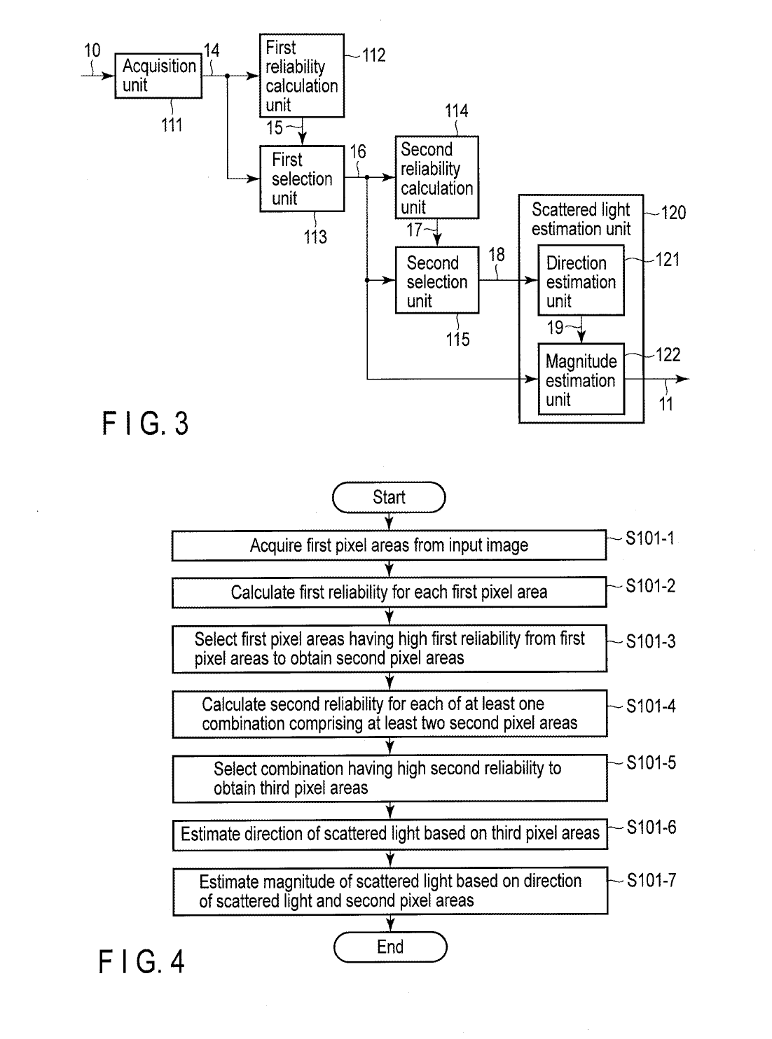

An example of image processing performed by the image processing apparatus shown in FIG. 1 will be described with reference to FIG. 2. When the image processing shown in FIG. 2 starts, the scattered light acquisition unit 101 acquires the scattered light 11 included in each pixel of the input image 10 (step S101). Step S101 will be described with reference to FIGS. 3 and 4 below in detail.

The control information acquisition unit 102 acquires the control information 12 based for example on user input (step S102). Since steps S101 and S102 are independent, they may be executed in an order different from that shown in FIG. 2. Step S102 will be described with reference to FIG. 6 in detail.

The scattered light control unit 103 generates the output image 13 by controlling the amount of the scattered light 11 included in each pixel of the input image 10 acquired in step S101 based on the control information 12 acquired in step S102 (step S103).

Step S101 shown in FIG. 2 will be described in detail. The scattered light acquisition unit 101 may execute scattered light acquisition processing shown in FIG. 4, for example, in step S101. In this case, the scattered light acquisition unit 101 may comprise an acquisition unit 111, a first reliability calculation unit 112, a first selection unit 113, a second reliability calculation unit 114, a second selection unit 115 and a scattered light estimation unit 120, as shown in FIG. 3.

The acquisition unit 111 acquires a plurality of first pixel areas 14 from the input image 10. The acquisition unit 111 outputs the plurality of first pixel areas 14 to the first reliability calculation unit 112 and the first selection unit 113.

The first pixel areas 14 may be areas obtained, for example, by dividing the input image 10 into blocks. The first pixel areas 14 are hereinafter assumed to be areas obtained by dividing the input image 10 into blocks. Alternatively, the first pixel areas 14 may be obtained, for example, by dividing each of at least one object in the input image 10 into pieces.

The first pixel areas 14 each comprises a plurality of pixels. The plurality of pixels are not necessary to be spatially continuous. However, in general, the color of reflected light depends on the object. Thus, the total number of objects included in each of the first pixel areas 14 is preferably small. For example, the acquisition unit 111 may acquire the plurality of the first pixel areas 14 by reducing the input image 10 in the horizontal direction or the vertical direction and dividing the reduced input image 10 into blocks or dividing each of at least one object in the reduced input image 10 into pieces.

The first reliability calculation unit 112 inputs the plurality of first pixel areas 14 from the acquisition unit 111. The first reliability calculation unit 112 calculates a first reliability 15 for each of the plurality of first pixel areas 14. The first reliability calculation unit 112 outputs a plurality of the first reliabilities 15 to the first selection unit 113.

The first reliability 15 evaluates the reliability of each of the first pixel areas 14 in estimation of the scattered light 11 in the input image 10, described below. That is, using first pixel areas 14 with a high first reliability 15 improves the accuracy of estimation for the scattered light. The first reliability 15 will be described below in detail.

The first selection unit 113 inputs the plurality of first pixel areas 14 from the acquisition unit 111, and inputs the plurality of first reliabilities 15 from the first reliability calculation unit 112. The first selection unit 113 selects those of the first pixel areas 14 which have high first reliabilities 15 to obtain a plurality of second pixel areas 16. The first selection unit 113 outputs the plurality of second pixel areas 16 to the second reliability calculation unit 114, second selection unit 115 and scattered light estimation unit 120.

Concretely, the first selection unit 113 can obtain the plurality of second pixel areas 16 by selecting those of the first pixel areas 14 which have first reliabilities 15 greater than or equal to a first threshold value, or by selecting a predetermined number (but at least two) of first pixel areas 14 in order of decreasing first reliability 15.

The second reliability calculation unit 114 inputs a plurality of second pixel areas 16 from the first selection unit 113. The second reliability calculation unit 114 calculates a second reliability 17 for each of at least one combination including at least two of the plurality of second pixel areas 16. Concretely, the second reliability calculation unit 114 calculates the second reliability 17 so that the second reliability 17 increases as the sum of the levels of orthogonality indicative of the angular orthogonality between at least one pair of estimated planes approximating the distribution of pixel values in the second pixel areas 16 included in the combination (the sum may also referred to as the level of independence) increases. The second reliability will be described below in detail. The second reliability calculation unit 114 outputs at least one second reliability 17 to the second selection unit 115. However, as described below, the second reliability calculation unit 114 does not have to calculate the second reliability 17 for all the combinations.

The second selection unit 115 inputs the plurality of second pixel areas 16 from the first selection unit 113, and inputs at least one second reliability 17 from the second reliability calculation unit 114. The second selection unit 115 selects a combination with a high second reliability 17 from at least one combination including at least two second pixel areas 16 to obtain a plurality of third pixel areas 18. Concretely, the second selection unit 115 can obtain the plurality of third pixel areas 18 by selecting a combination with the highest second reliability 17 from the at least one combination. The second selection unit 115 outputs the plurality of third pixel areas 18 to the scattered light estimation unit 120.

The scattered light estimation unit 120 inputs the second pixel areas 16 from the first selection unit 113, and inputs the third pixel areas 18 from the second selection unit 115. The scattered light estimation unit 120 estimates the scattered light 11 included in each pixel of the input image 10 based on the second pixel areas 16 and the third pixel areas 18.

Concretely, it is assumed that a given pixel area corresponds to a local uniform reflective surface of the object, and in the given pixel area, a pixel value varies only by differences, among the pixels, in the brightness of reflected light from the object and the amount of scattered light mixed in the reflected light. According to this, any pixel value in a given pixel area is determined by alpha blending of the color of the light reflected from the object and the scattered light 11. That is, any pixel value in a given pixel area occupies a point on an ideal plane formed by the linear sum of the vector of the color of the reflected light and the vector of the scattered light 11 in the color space. As described above, the scattered light 11 is uniform in the input image 10. Hence, the vector of the scattered light 11 is indicated by the cross line between different ideal planes which are formed by the linear sums of the vector of the scattered light 11 and each of the vectors of the different colors of reflected light in different pixel areas. Based on this assumption, the scattered light estimation unit 120 can estimate the scattered light 11.

The scattered light estimation unit 120 may estimate the scattered light 11 based on the third pixel areas 18 without inputting the second pixel areas 16. In this case, the first selection unit 113 does not output the second pixel areas 16 to the scattered light estimation unit 120. The scattered light estimation unit 120 may estimate the scattered light 11 based on the second pixel areas 16 without inputting the third pixel areas 18. In this case, there is no need to provide the second reliability calculation unit 114 and the second selection unit 115.

The scattered light estimation unit 120 may comprises a direction estimation unit 121 and a magnitude estimation unit 122, as shown in FIG. 3.

The direction estimation unit 121 inputs the plurality of third pixel areas 18 from the second select unit 115. The direction estimation unit 121 estimates a direction 19 of scattered light based on the plurality of third pixel areas 18. The direction estimation unit 121 outputs an estimated direction 19 of scattered light to the magnitude estimation unit 122.

The magnitude estimation unit 122 inputs the plurality of second pixel areas 16 from the first selection unit 113, and inputs the direction 19 of the scattered light from the direction estimation unit 121. The magnitude estimation unit 122 estimates the magnitude of the color of the scattered light based on the direction 19 of the scattered light and the second pixel areas 16. The magnitude estimation unit 122 multiplies the direction 19 of the scattered light by the estimated magnitude of the color of the scattered light to obtain the scattered light 11. The magnitude estimation unit 122 outputs the information of the scattered light 11.

The magnitude estimation unit 122 may inputs the third pixel areas 18 from the second selection unit 115 instead of the first selection unit 113 and estimates the magnitude of the color of scattered light based on the third pixel areas 18. In this case, the first selection unit 113 does not output the second pixel areas 16 to the magnitude estimation unit 122.

An example of scattered light acquisition processing by the scattered light acquisition unit shown in FIG. 3 will be described with reference to FIG. 4. When the scattered light acquisition processing in FIG. 4 starts, step S101-1 is carried out.

In step S101-1, the acquisition unit 111 acquires the plurality of first pixel areas 14 from the input image 10. The first reliability calculation unit 112 calculates first reliability 15 for each of the first pixel areas 14 acquired in step S101-1 (step S101-2).

The first selection unit 113 selects first pixel areas 14 whose first reliability calculated in step S101-2 is high from the first pixel areas 14 acquired in step S101-1 to obtain the plurality of second pixel areas 16 (step S101-3).

The second reliability calculation unit 114 calculates the second reliability 17 for each of at least one combination comprising at least two second pixel areas 16 obtained in step S101-3 (step S101-4). The second selection unit 115 selects a combination having a high second reliability 17 calculated in step S101-4 among the at least one combination to obtain the plurality of third pixel areas 18 (steps S101-5).

The direction estimation unit 121 estimates the direction 19 of scattered light based on the plurality of third pixel areas 18 obtained in step S101-5 (step 101-6). The magnitude estimation unit 122 estimates the magnitude of the color of the scattered light based on the second pixel areas 16 obtained in steps S101-3 and the direction 19 of the scattered light estimated in step S101-6, and multiplies the direction 19 of the scattered light by the estimated magnitude of the color of the scattered light to obtain the scattered light 11 (step S101-7). The scattered light acquisition processing in FIG. 4 is completed upon completion of step S101-7.

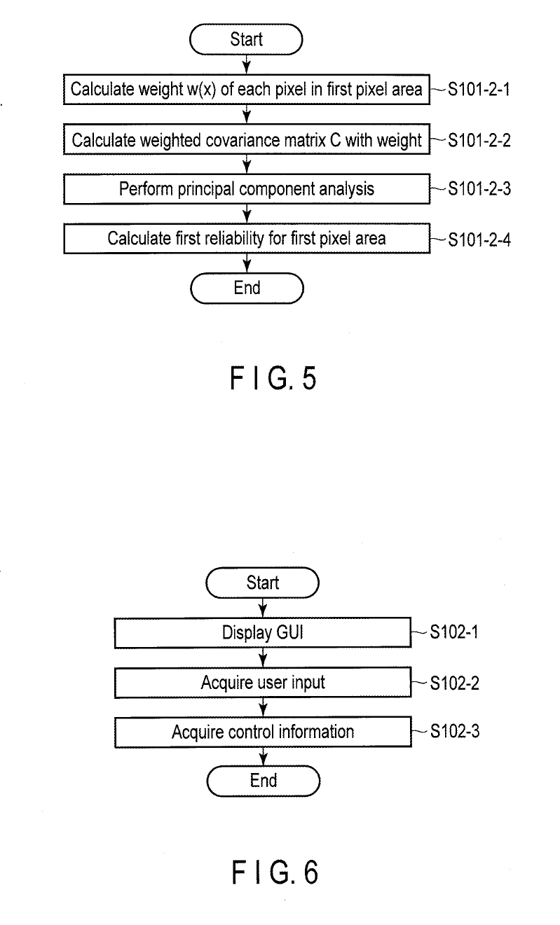

Step S101-2 in FIG. 4 is realized, for example, by performing the first reliability calculation processing shown in FIG. 5 for each of the first pixel areas 14. When the first reliability calculation processing shown in FIG. 5 starts, step S101-2-1 is carried out.

In step S101-2-1, the first reliability calculation unit 112 calculates weight w(x) of each pixel in the first pixel area 14. Here, x denotes a position vector identifying each pixel and which can be expressed, for example, by the coordinates of the pixel in the input image 10. The pixel value of pixel x is given by I(x)=(I₁(x), I₂(x), I₃(x))^{t}, where I(x) denotes a three-dimensional vector having the RGB value of pixel x as an element. Weight w(x) is calculated to be higher as the color difference d(x_{c}, x) between pixel x and pixel of interest x_{c} described below decreases.

Pixel of interest x_{c} is any one of the plurality of pixels in the first pixel area 14. Pixel of interest x_{c} may be, for example, a pixel occupying a particular position in the first pixel area 14 (for example, a central position of the first pixel area 14) or a pixel with a pixel value closest to an average pixel value within the first pixel area 14. Alternatively, pixel of interest x_{c} may be any pixel in the first pixel area 14 which is not selected based on the position or the pixel value. Pixel of interest x_{c} is hereinafter defined to occupy the central position in the first pixel area 14.

The color difference d(x_{c}, x′) between pixel of interest x_{c} and another peripheral pixel x′ is given by Equation (1) shown below. The color difference d(x_{c}, x_{c}) between pixel of interest x_{c} and pixel of interest x_{c} is considered to be zero.

$$d ( {x}_{C} , {x}^{′} ) = min \{ \vert θ ( {x}_{C} ) - θ ( {x}^{′} ) \vert , 2 π - \vert θ ( {x}_{C} ) - θ ( {x}^{′} ) \vert \} \\ θ ( {x}_{C} ) = {tan}^{- 1} \{ \frac{U ( {x}_{C} )}{V ( {x}_{C} )} \} \\ θ ( {x}^{′} ) = {tan}^{- 1} \{ \frac{U ( {x}^{′} )}{V ( {x}^{′} )} \} \qquad ( 1 )$$

In Equation (1), U(x) denotes a U component of a pixel value I(x) in a YUV color space, and V(x) denotes a V component of pixel value I(x) in the YUV color space. As is apparent from Equation (1), the value of the color difference d(x_{c}, x′) decreases as the similarity between the color of pixel of interest x_{c} and the color of peripheral pixel x′ becomes higher.

Weight w(x) is calculated to be higher as the color difference d(x_{c}, x) between pixel of interest x_{c} and pixel x becomes smaller.

$$w ( x ) = exp ( \frac{- {d ( {x}_{C} , x )}^{2}}{{σ}_{θ}^{2}} ) \qquad ( 2 )$$

In Expression (2), σ_{θ} is a constant. Weight w(x) calculated by Equation (2) is not less than 0 and not greater than 1.

The first reliability calculation unit 112 uses weight w(x) calculated in step S101-2-1 to calculate a covariance matrix C for the distribution of pixel values in the first pixel area 14 (step S101-2-2). The first reliability calculation unit 112 calculates an element Cᵢⱼ in the i^{th} row and the j^{th} column of the covariance matrix C by:

$${c}_{ij} = \frac{1}{w} {\sum }_{n = 1}^{N} {x}_{ni}^{T} {x}_{nj} w ( {x}_{n} ) \\ {x}_{np} = {x}_{np} - \overline{{x}_{p}} \\ \overline{{x}_{p}} = \frac{1}{N} {\sum }_{n = 1}^{N} {x}_{np} \\ w = {\sum }_{n ∈ R} w ( {x}_{n} ) \qquad ( 3 )$$

As described above, since it is assumed that the RGB space is a color space, i, j=1, 2, 3 in Equation (3). In addition, R denotes the first pixel area 14, n denotes an index which identifies the individual pixels in the first pixel area 14 (=R) and which can be one of consecutive natural numbers from 1 to N. That is, N denotes the total number of pixels in the first pixel area 14 (=R). Further, xₙ denotes the position vector of a pixel identified by n, xₙₚ denotes the pth element of a pixel value I(xₙ), p=1, 2, 3. Equation (3) indicates that contribution from pixel to the covariance matrix C increases as the similarity in color of the pixel to pixel of interest x_{c} becomes greater, and the covariance matrix C is thus effective for approximating a uniform reflective surface in the first pixel area 14. Concretely, the first pixel area 14 may be mixed with colors, noise, and the like which are different from those from the uniform reflective surface, but the adverse effect of this mixture is reduced by the above-described weighting.

The first reliability calculation unit 112 carries out principal component analysis on the covariance matrix C calculated in step S101-2-2 (step S101-2-3). Concretely, the first reliability calculation unit 112 calculates an eigenvector and an eigenvalue for the first principal component of the covariance matrix C, an eigenvector and an eigenvalue for the second principal component, and an eigenvector and an eigenvalue for the third principal component.

Based on the results of the principal component analysis carried out in step S101-2-3, the first reliability calculation unit 112 calculates the first reliability 15 for the first pixel area 14 (step S101-2-4). When step S101-2-4 is completed, the first reliability calculation process on the first pixel area 14 ends. The first reliability 15 will be described below in detail.

It is assumed that the first pixel area 14 corresponds to the local uniform reflective surface of the object, and in the first pixel area 14, the pixel value varies only by a difference, among the pixels, in the brightness of light reflected from the object and the amount of scattered light mixed in the reflected light. If this assumption is true, any pixel value in the first pixel area 14 occupies a point on an ideal plane formed by the linear sum of the vector of the color of the reflected light and the vector of the scattered light 11 in the color space. Further, all the pixel values in the first pixel area 14 are distributed on the ideal plane. In other words, in theory, estimating the plane on which the pixel values in the first pixel area 14 are distributed indirectly derives the ideal plane for the first pixel area 14 as an estimated plane for the first pixel area 14. The estimated plane for the first pixel area 14 (=R) is formed by the linear sum of eigenvector v^{R}₁ of the first principal component and eigenvector v^{R}₂ of the second principal component that are included in the results of the principal component analysis in step S101-2-3.

However, if the first pixel area 14 does not correspond to the local uniform reflective surface of the object, or noise is added to the pixel value, the pixel value varies by a factor that is inconsistent with the above-described assumption. Hence, the pixel values in the first pixel area 14 are not necessarily distributed on the ideal plane. The estimated plane for the first pixel area 14 does not necessarily match the ideal plane for the first pixel area 14.

The scattered light 11 is theoretically estimated based on different ideal planes but actually needs to be estimated based on different estimated planes. That is, an estimated plane significantly different from the ideal plane (that is, an inaccurate estimated plane) may reduce the accuracy of estimation of the scattered light 11. Thus, calculating the reliability for the first pixel area 14 in the estimation of the scattered light 11 (the accuracy of the estimated plane for the first pixel area 14) improves the accuracy of estimation of the color 14 of the scattered light 11.

The first reliability 15 is calculated mainly based on part of or all of the three evaluation criteria described below.

The first evaluation criterion is how planar the distribution of the pixel values in the first pixel area 14 is in the color space. The reliability of the first pixel area 14 increases as the flatness, in the color space, of the distribution of the pixel values in the first pixel area 14 increases (in other words, as the pixel values in the first pixel area 14 become closer to any plane in the color space). An evaluation value for the first evaluation criterion is denoted by e₀. A greater evaluation value e₀ means greater flatness of the distribution of the pixel values in the first pixel area 14. Evaluation value e₀ may also be referred to as the flatness. Evaluation value e₀ may be calculated based on the eigenvalue of the third principal component included in the results of the principal component analysis in step S101-2-3.

A second evaluation criterion is how widely the pixel values in the first pixel area 14 are distributed on the estimated plane for the first pixel area 14. The reliability of the first pixel area 14 increases as the wideness of the distribution of the pixel values in the first pixel area 14 on the estimated plane for the first pixel area 14 increases. An evaluation value for the second evaluation criterion is denoted by e₁. A greater evaluation value e₁ means a wider distribution of the pixel values in the first pixel area 14 on the estimated plane for the first pixel area 14. Evaluation value e₁ may also be referred to as the degree of plane dispersion. Evaluation value e₁ may be calculated based on the eigenvalue of the first principal component and the eigenvalue of the second principal component included in the results of the principal component analysis in step S101-2-3. For example, evaluation value e₁ may be calculated to increase as the sum of the eigenvalues of the first and second principal components increases. Alternatively, evaluation value e₁ may be calculated exclusively based on the eigenvalue of the second principal component.

A third evaluation criterion is how far the estimated plane for the first pixel area 14 lies from the origin of the color space. Both the vector of the scattered light 11 and the vector of the color of the reflected light in the first pixel area 14 pass through the origin of the color space, and thus the ideal plane formed by the vectors also passes through the origin. Hence, the reliability of the first pixel area 11 increases as the distance between the estimated plane for the first pixel area 14 and the origin of the color space decreases. An evaluation value for the third evaluation criterion is denoted by e₂. A greater evaluation value e₂ means a shorter distance between the estimated plane for the first pixel area 14 and the origin of the color space.

The first reliability calculation unit 112 calculates the first reliability 15 (=E1(R)) for the first pixel area 14 (=R) by:

E1(R)=w₀e₀+w₁e₁+w₂e₂ (4)

In Equation (4), w₀, w₁, and w₂ denote weights which are not less than 0 or more and not greater than 1. However, at least one of weights w₀, w₁, and w₂ is greater than 0. In other words, the first reliability calculation unit 112 calculates the first reliability 15 (=E1(R)) for the first pixel area 14 (=R) so that the first reliability 15 increases as at least one of evaluation values e₀, e₁, and e₂ increases. Besides Equation (4), for example, the product of at least two of evaluation values e₀, e₁, and e₂ may be used to calculate the first reliability 15 (=E1(R)).

As described above, the first selection unit 113 selects those of the plurality of first pixel areas 14 which have high first reliabilities 15 to obtain the plurality of second pixel areas 16. That is, those of the plurality of first pixel areas 14 which are determined to be reliable in the estimation of the scattered light 11 are selected as the plurality of second pixel areas 16. The scattered light estimation unit 120 utilizes the plurality of second pixel areas 16, thereby accurately estimating the scattered light 11.

The second reliability 17 calculated in step S101-4 will be described in detail. Typically, the second reliability 17 of any combination is the sum of the levels of orthogonality between at least one pair of estimated planes approximating the distribution of pixel values in the second pixel areas 16 included in the combination (the sum may also referred to as the level of independence).

The total number of combinations including at least two of the plurality of second pixel areas 16 is generally enormous. Consequently, in actuality, calculating the second reliability 17 for all the combinations may be difficult. Thus, preferably, the second reliability calculation unit 114 utilizes a greedy algorithm, for example, so that an appropriate combination is selected as the plurality of third pixel areas 18 while the calculation amount of the second reliability 17 is reduced.

The second reliability calculation unit 114 calculates the second reliability 17 for each of at least one combination including two second pixel areas 16 (=Rᵢ, Rⱼ) in accordance with Equation (5) shown below, for example, to search for a combination that maximizes the second reliability 17.

$${max}_{{{R}_{i} , {R}_{j} ∈ W 1}_{( i \neq j )}} \{ 1 - {〈 {v}_{3}^{{R}_{i}} , {v}_{3}^{{R}_{j}} 〉}^{2} \} \qquad ( 5 )$$

In Equation (5), v^{Ri}₃ and v^{Rj}₃ denote the eigenvectors of the third principal components of weighted covariance matrices C of the distributions of pixel values in the second pixel areas 16 (=Rᵢ, Rⱼ). The eigenvectors of the third principal components correspond to normals of estimated planes for the second pixel areas 16. W₁ denotes a set of the plurality of the second pixel areas 16. Further, in Equation (5), one of the second pixel areas 16 (=Rᵢ or Rⱼ) may be fixed to one of the second pixel areas 16 which has the highest reliability 15. This technique reduces the amount of calculation in Equation (5).

Subsequently, the second reliability calculation unit 114 calculates, for example, by Equation (6) shown below, an increment in the second reliability 17 obtained when n (n≧2) second pixel areas 16 that maximize the second reliability 17 are combined with an additional second pixel area 16, and further searches for a combination that maximizes the increment in the second reliability 17. That is, the second reliability calculation unit 114 can increase the total number of second pixel areas 16 included in the combination to two, three, . . . while narrowing down calculation targets for the second reliability 17.

$${max}_{{R}_{k} ( {R}_{k} ∉ {W}_{2} )} {\sum }_{{R}_{i} ∈ {W}_{2}} \{ 1 - {〈 {v}_{3}^{{R}_{i}} , {v}_{3}^{{R}_{k}} 〉}^{2} \} \qquad ( 6 )$$

In Equation (6), W₂ denotes a set of n second pixel areas 16 searched for by the present algorithm. That is, the number of elements of the set W₂ increases sequentially to two, three, . . . .

The second reliability calculation unit 114 may stop the calculation of the second reliability 17, for example, when n reaches a predetermined number or when the second reliability 17 becomes greater than or equal to a second threshold value. Alternatively, the second reliability calculation unit 114 may stop the calculation of the second reliability 17 when the change in the second reliability 17 becomes smaller than a predetermined specific value.

In step S101-6, it is necessary to derive estimated planes of the plurality of second pixel areas 16 to estimate the direction 19 of the color of the scattered light. That is, similar to the aforementioned first reliability calculation unit 112, calculations of a weight w(x) (same as step S101-2-1) and a weighted covariance matrix C (same as step S101-2-2) and principal component analysis (same as step S101-2-3) have to be performed for each of the plurality of second pixel areas 16. The direction estimation unit 121 may perform the above operations independently of the first reliability calculation unit 112 or reutilize the results of the processing by first reliability calculation unit 112.

The estimated plane for the second pixel area 16 (=R) is formed by the linear sum of eigenvector v^{R}₁ of the first principal component of the weighted covariance matrix C for the second pixel area 16 (=R) and eigenvector v^{R}₂ of the second principal component of the weighted covariance matrix C for the second pixel area 16 (=R). Ideally, each of the estimated planes for the plurality of second pixel areas 16 contains the vector of the scattered light 11. That is, the cross line between the estimated planes for different second pixel areas 16 indicates the vector of the scattered light 11.

Thus, the direction estimation unit 121 can estimate a vector A_{d} indicative of the direction 19 of the scattered light by:

$${max}_{{A}_{d}} {\sum }_{R} ( {〈 {A}_{d} , {v}_{1}^{R} 〉}^{2} + {〈 {A}_{d} , {v}_{2}^{R} 〉}^{2} ) where ‖ {A}_{d} ‖ = 1 \qquad ( 7 )$$

Equation (7) indicates vector A_{d} having the largest total magnitude when projected on each of the estimated planes for the plurality of second pixel areas 16. Actually, the direction estimation unit 121 derives vector A_{d} in Equation (7) by calculating the eigenvector of the first principal component of a 3×3 matrix determined by:

Σ_{R}(v₁^{R}(v₁^{R})^{t}+v₂^{R}(v₂^{R})^{t}) (8)

Alternatively, the direction estimation unit 121 may estimate a predetermined direction in the color space to be the direction 19 of the scattered light without using Equations (7) to (8). In this case, the direction estimation unit 121 does not have to input the plurality of second pixel areas 16.

For example, if the input image 10 has been captured in the daytime, the scattered light 11 can be expected to be close to white (an achromatic color other than black) as a result of Mie scattering. Hence, the direction estimation unit 121 may estimate a vector having a magnitude of 1 and acting in the same direction as that of a vector (1, 1, 1) in the RGB space to be the direction 19 of the color of the scattered light.

If the input image 10 is of a sunset, the scattered light can be expected to be close to red. Hence, the direction estimation unit 121 may estimate a vector (1, 0, 0) in the RGB space to be the direction 19 of the color of the scattered light. If the input image 10 has been captured under water, the scattered light can be expected to be close to blue. Thus, the direction estimation unit 121 may estimate a vector (0, 0, 1) in the RGB color space to be the direction 19 of the color of the scattered light.

In addition, the direction 19 of the color of the scattered light may be estimated by manually or automatically detecting the pixel value of an area which is blurred most, the pixel value of an area indicating sky or the pixel value of an area indicating the vicinity of the horizon in the input image 10.

In step S101-7, the magnitude estimation unit 122 estimates magnitude of the color of scattered light as indicated below. As described above, each of the plurality of second pixel areas 16 is assumed to correspond to a uniform reflective surface. Hence, in any second pixel area 16, any pixel value I(x) can be determined by Equation (9) shown below. The vector of the color of reflected light in this second pixel area 16 is denoted by J, and the vector of the scattered light 11 is denoted by A. Further, when the magnitude of the color of the scattered light is denoted by α, A=αA_{d}.

I(x)=t(x)l(x)J+(1−t(x))A (9)

In Equation (9), t(x) denotes a parameter (not less than 0 and not greater than 1) which affects the amount of scattered light mixed in a pixel x, and it may also referred to as the transmittance. Further, l(x) denotes a parameter (not less than 0 and not greater than 1) which affects change in brightness of the reflected light in pixel x. Parameters l(x) and t(x) may be considered to be independent of each other. Hence, the magnitude estimation unit 122 can estimate the magnitude of the color of the scattered light by deriving α that minimizes the absolute value of a covariance C (l(x), t(x)) of parameters l(x) and t(x).

For example, the magnitude estimation unit 122 can search for the minimum value of the covariance C (l(x), t(x)) by varying α over a specific range for any second pixel area 16 (=R). Concretely, the magnitude estimation unit 122 sets α to an initial value α₁ and also sets vector A of the scattered light 11 to α₁A_{d}. Based on vector A=α₁A_{d} of the scattered light 11, the magnitude estimation unit 122 derives a value C₁ of the covariance C(l(x)J, t(x)) by using Equation (18) shown later and the following Equation (10):

$$1 ( x ) J = \frac{I ( x ) - ( 1 - t ( x ) A )}{t ( x )} \qquad ( 10 )$$

The magnitude estimation unit 122 can similarly derive values C₂, C₃, . . . of the covariance C(l(x)J, t(x)) for α₂, α₃, . . . . Then, the magnitude estimation unit 122 can search for the minimum Cᵢ of values C₁, C₂, C₃, . . . and estimate the corresponding αᵢ to be the magnitude α_{R} of the color of the scattered light based on the second pixel area 16 (=R). Thus, vector A_{R} for the scattered light 11 based on the second pixel area 16 (=R) equals α_{R}A_{d}. The estimated magnitude of the color of the scattered light (=α_{R}) may vary for each second pixel area 16. Since the scattered light 11 is assumed to be uniform within the input image 10, the magnitude estimation unit 122 may estimate vector Aᵢ of the scattered light 11 in the input image 10, for example, by:

$$\begin{matrix}‖ {A}_{i} ‖ = \frac{1}{{N}_{R}} {\sum }_{R} ‖ {A}_{R} ‖ \\ = \frac{1}{{N}_{R}} {\sum }_{R} {α}_{R}\end{matrix} \qquad ( 11 )$$

In Equation (11), N_{R} denotes the total number of pixel areas (for example, the second pixel areas 16) utilized to estimate the magnitude of the color of the scattered light. With Equation (11), the magnitude estimation unit 122 estimates the arithmetic mean of the magnitude α_{R} of the color of the scattered light estimated for each second pixel area 16 to be the magnitude of vector Aᵢ of the scattered light 11 in the input image 10.

The control information acquisition unit 102 may execute the control information acquisition processing show in FIG. 6 in aforementioned step S102. When the control information acquisition processing shown in FIG. 1 starts, step S102-1 is carried out.

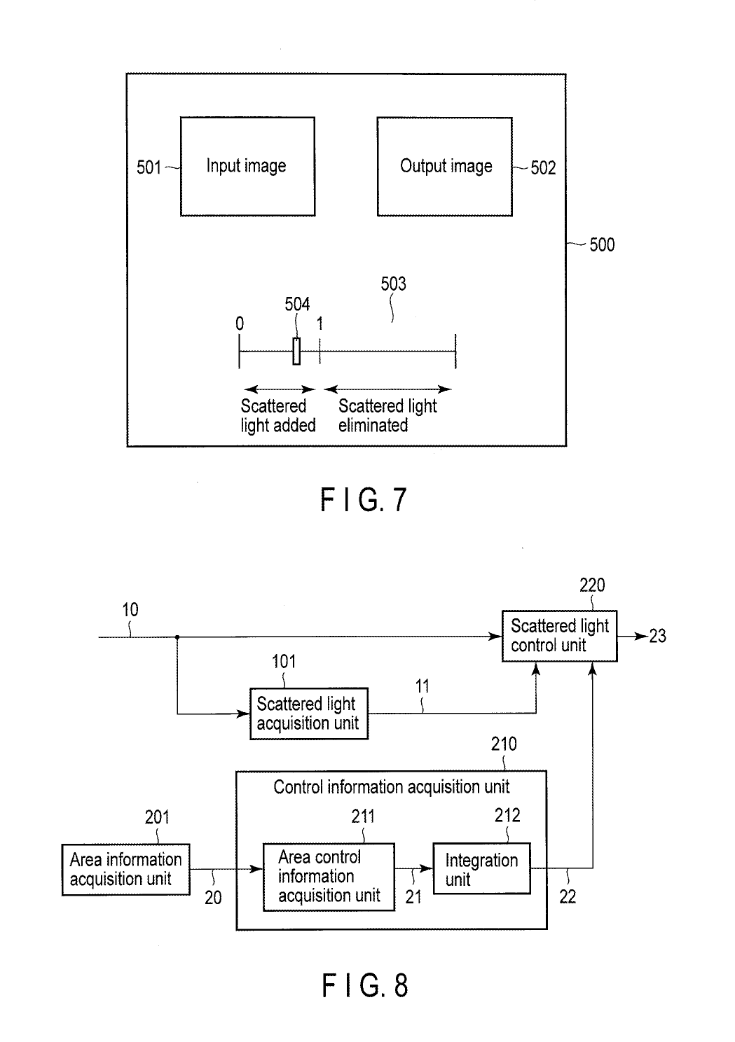

In step S102-1, the control information acquisition unit 102 displays a GUI 500 shown in FIG. 7, for example, on a display device not shown in the figures. The GUI 500 may be displayed on the whole screen of the display device or in a window on part of or the entire screen. The GUI 500 will be described below in detail.

The control information acquisition unit 102 acquires user input through the GUI displayed in step S102-1 (step S102-2). The control information acquisition unit 102 acquires the control information 12 based on the user input acquired in step 102-2 (step S102-3).

The GUI 500 includes an input image display area 501, an output image display area 502, a slide bar 503 and a slider 504. In the input image display area 501, the input image 10 itself or the input image 10 which has been reduced or enlarged or subjected to color space conversion may be displayed.

In the output image display area 502, an output image 13 generated based on a provisional value of the control information 12 relative to the present user input or the output image 13 which has been reduced or enlarged or subjected to color space conversion may be displayed. The output image 13 may be generated by the scattered light control unit 103 based on the provisional value of the control information 12 and supplied to the control information acquisition unit 102, or directly generated by the control information acquisition unit 102 based on the provisional value. Providing the input image display area 501 and the output image display area 502 in the same interface allows the user to easily make fine adjustment of the control information 12 while checking the final output image 13.

The slider 504 moves along the slide bar 503 in accordance with user input (for example, click, touch, drag, etc.). The positional information of the slider 504 is associated with the control information 12. Accordingly, the control information acquisition unit 102 can derive control information 12 based on the positional information of the slider 504.

In FIG. 7, the control information 12 is a ratio of transmittance of each pixel of the output image 13 to transmittance of corresponding pixel of the input image 10, for example. A pixel value I(x) of the input image 10 is given by:

I(x)=t(x)J(x)+(1−t(x))A (12)

where J(x) denotes a vector of reflected light in pixel x which is equal to l(x)J in Equation (9). If it is assumed that the transmittance of pixel x of the output image 13 is t′(x), the ratio of transmittance of each pixel of the output image 13 to transmittance of corresponding pixel of the input image 10 is given by:

$$r ( x ) = \frac{{t}^{′} ( x )}{t ( x )} \qquad ( 13 )$$

Since the transmittance t′(x) in pixel x of the output image 13 is not less than 0 and not more than 1, control information r(x) is greater than or equal to zero. In the present embodiment, r(x) does not vary in accordance with x; however, r(x) may vary in accordance with x as explained in the second embodiment.

In accordance with Equations (12) and (13), a pixel value I(x) of the output image 13 can be determined by:

$$\begin{matrix}{I}^{′} ( x ) = r ( x ) I ( x ) + ( 1 - r ( x ) ) A \\ = {t}^{′} ( x ) J ( x ) + ( 1 - {t}^{′} ( x ) ) A\end{matrix} \qquad ( 14 )$$

In accordance with Equations (13) and (14), when the control information r(x) is less than 1, the transmittance t′(x) of pixel x of the output image 13 is less than the transmittance t(x) of pixel x of the input image 10. That is, since the ratio of scattered light 11 in pixel x of the output image 13 becomes greater than that in pixel x of the input image 10, the output image 13 is generated so that the scattered light is added (or emphasized).

When the control information r(x) is greater than 1, the transmittance t′(x) of pixel x of the output image 13 becomes greater than the transmittance t(x) of pixel x of the input image 10. That is, since the ratio of scattered light 11 in pixel x of the output image 13 becomes less than that in pixel x of the input image 10, the output image 13 is generated so that the scattered light is eliminated (or suppressed).

When the control information r(x) is 1, the transmittance t′(x) of pixel x of the output image 13 becomes equal to the transmittance t(x) of pixel x of the input image 10. That is, the output image 13 is generated so that the scattered light is maintained (i.e., the same as input image 10).

As can be seen from Equation (13), even if the transmittance t(x) of pixel x of the input image 10 is unknown, the transmittance t′(x) of pixel x of the output image 13 can be controlled to be equal to r(x)t(x) based on the control information r(x). Namely, calculation of the transmittance t(x) can be omitted, thereby generating the output image 13 with reduced computation.

As stated above, the slide bar 503 and slider 504 are provided in the GUI 500 to acquire user input. As show in FIG. 7, the slide bar 503 may be displayed with a label indicating the setting values of control information 12 (for example, “0,” “1,” etc.) or with a label indicating effects applied to the output image 13 such as “scattered light added,” “scattered light maintained,” “scattered light eliminated” or the like.

The GUI 500 may be configured with different types of GUI components other than the slide bar 503 and slider 504.

For example, a plurality of buttons, each of which is associated with a certain value set to the control information 12, for designating a value set to the control information 12 may be provided in the GUI 500. In this structure, the control information acquisition unit 102 can acquire the control information 12 in response to user input (for example, selection of a button by click or touch). The buttons may be displayed with a label indicating the setting values of control information 12 such as “0.5,” “1.0” and “2.0” or with a label indicating effects applied to the output image 13 such as “scattered light added,” “scattered light maintained,” “scattered light eliminated” or the like.

In addition, a plurality of buttons for sequentially increasing or decreasing the control information 12, each of which is associated with a certain increment or decrement value relative to the provisional value of the control information 12, may be provided in the GUI 500. In this structure, the control information acquisition unit 102 stores the provisional value of the control information 12 and updates the provisional value in response to user input in order to acquire the latest control information 12.

Further, a box for directly inputting the set value to the control information 12 may be provided in the GUI 500. A combination of multiple types of GUI components may be provided in the GUI 500 to acquire user input.

As explained above, the image processing apparatus according to the first embodiment acquires control information relative to an input image, and adjusts the amount of scattered light included in each pixel of the input image based on the control information to generate an output image. The image processing apparatus selectively applies image processing to suppress, maintain or emphasize the scattered light based on the input image, thereby adjusting the depth feel of the output image depending on the purpose.

### Second Embodiment

As illustrated in FIG. 8, an image processing apparatus according to the second embodiment comprises a scattered light acquisition unit 101, an area information acquisition unit 201, a control information acquisition unit 210 and a scattered light control unit 220. The image processing apparatus shown in FIG. 8 generates an output image 23 by controlling the amount of scattered light 11 included in each pixel of an input image 10 based on control information 22.

The area information acquisition unit 201 acquires area information 20. The area information 20 specifies a plurality of areas obtained by dividing the input image 10. The area information acquisition unit 201 typically displays a GUI described below on a display device not shown in the figures, acquires user input by means of the GUI, and acquires the area information 20 based on the user input.

The control information acquisition unit 210 inputs the area information 20 from the area information acquisition unit 201. The control information acquisition unit 210 acquires the control information 22 based on the area information 20. The control information acquisition unit 210 comprises an area control information acquisition unit 211 and an integration unit 212.

The area control information acquisition unit 211 inputs the area information 20 from the area information acquisition unit 201. The area control information acquisition unit 211 acquires area control information 21 corresponding to each of the plurality of areas specified by the area information 20.

The area control information 21 may be the same as or similar to the control information 12 in the first embodiment. Concretely, the area control information 21 is a ratio of transmittance of corresponding pixel of the output image 23 to transmittance of each pixel within an area of interest of the input image 10, for example. In the first embodiment, the control information 12 is not changed in accordance with the position of pixel in the input image 10; however, the area control information 21 is not changed in accordance with the position of pixel within the corresponding area in the input image 10. The area control information 21 for a certain area may be the same as that for another area.

The area control information acquisition unit 211 may acquire area control information 21 by processing the same as or similar to that of the control information acquisition unit 102. The area control information acquisition unit 211 outputs a set of area control information 21 for the plurality of areas to the integration unit 212.

The integration unit 212 inputs the set of area control information 21 from the area control information acquisition unit 211. The integration unit 212 integrates the set of area control information 21 to generate the control information 22.

The scattered light control unit 220 receives the input image 10, inputs information of the scattered light 11 included in each pixel of the input image 10 from the scattered light acquisition unit 101, and inputs the control information 22 from the control information acquisition unit 210. The scattered light control unit 220 may further input information to specify an area in which each pixel of the input image 10 exists or information to specify a pixel existing in each area, if required. The scattered light control unit 220 controls the amount of the scattered light 11 included in each pixel of the input image 10 based on the control information 22 to generate the output image 23.

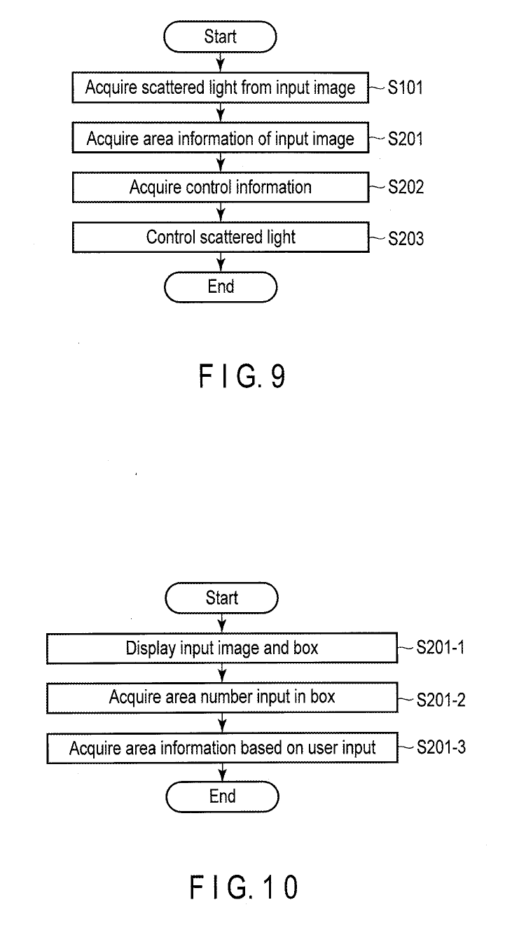

An example of image processing performed by the image processing apparatus shown in FIG. 8 will be described with reference to FIG. 9. When the image processing shown in FIG. 9 starts, step S101 is carried out. In FIG. 9, step S101 is the same as that shown in FIG. 2, and the detailed explanation will be omitted.

The area information acquisition unit 201 acquires the area information 20 based, for example, on user input (step S201). Since step S101, and steps S201 and S202 are independent, they may be executed in an order different from that shown in FIG. 9. However, step S202 must be performed after step S201.

The control information acquisition unit 210 acquires the control information 22 based on the area information 20 acquired in step S201 (step S202). The scattered light control unit 220 generates the output image 23 by controlling the amount of the scattered light 11 included in each pixel of the input image 10 acquired in step S101 based on the control information 22 acquired in step S201 (step S203).

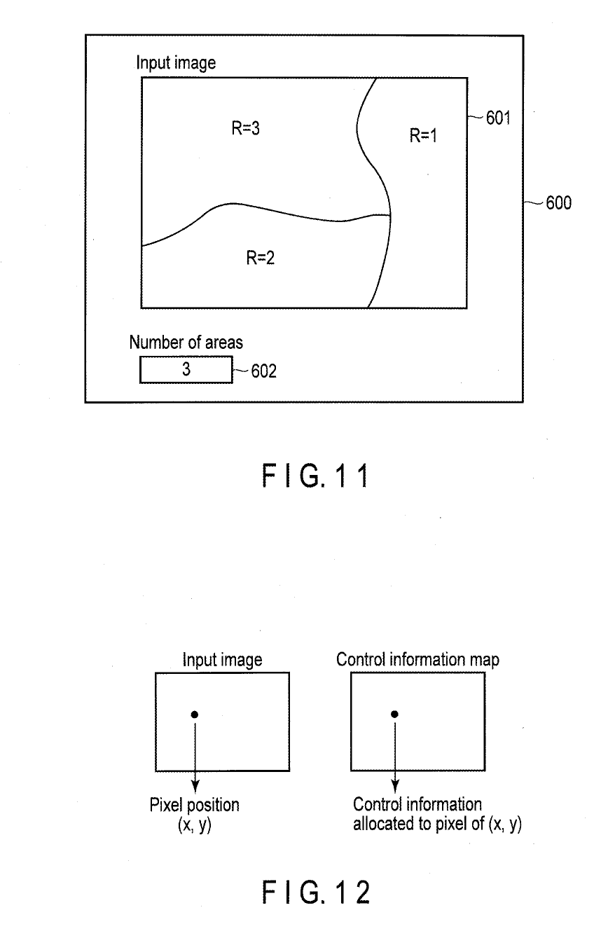

The step S201 is shown in FIG. 10 in detail. The area information acquisition unit 201 displays a GUI 600 shown in FIG. 11, for example, on a display device not shown in the figures (step S201-1). The GUI 600 may be displayed on the whole screen of the display device or in a window on part of or the entire screen.

The GUI 600 includes an input image display area 601 and a box 602. In the input image display area 601, the input image 10 itself or the input image 10 which has been reduced or enlarged or subjected to color space conversion may be displayed. A user can input a desired area number by means of the box 602.

When the user inputs a desired area number in the box 602, the area information acquisition unit 201 acquires the area number input in the box (step S201-2). In FIG. 11, “3” is input in the box 602, which means that the input image 10 will be divided into three areas.

The user can designate a plurality of areas by inputting the area number in the box 602 and operating the input image display area 601. Then, the area information acquisition unit 201 acquires the area information 20 based on the user input (step S201-3).

Concretely, the user may designates the boundary between areas. For example, the user can designate the boundary by dragging along a desired line, clicking or touching two or more points through which the desired line passes within the input image display area 601. The area information 20 may include coordinate information specifying each area or each boundary, for example.

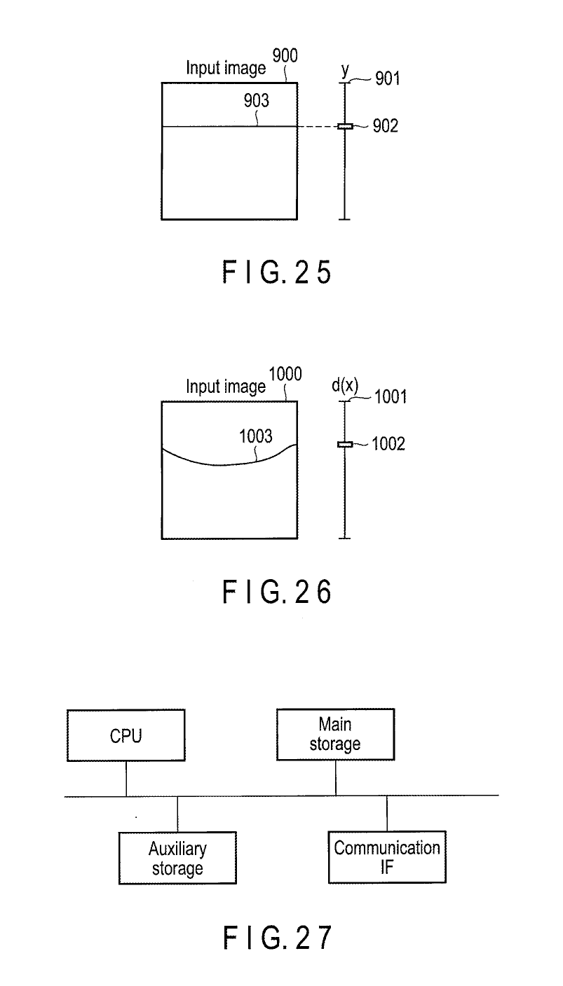

Alternatively, the GUI illustrated in FIG. 25 or 26 may be used to designate a boundary. The GUI of FIG. 25 includes an input image display area 900, a slide bar 901, a slider 902 and a boundary 903. In the input image display area 900, the input image 10 itself or the input image 10 which has been reduced or enlarged or subjected to color space conversion may be displayed.

The slider 902 moves along the slide bar 901 in accordance with user input (for example, click, touch, drag, etc.). Positional information of the slider 902 is associated with positional information of the boundary 903. Accordingly, the area information acquisition unit 201 can acquire the positional information of the boundary 903 based on the positional information of the slider 902. The boundary 903 is a straight line parallel to the horizontal axis, and the y coordinate is uniquely determined by the positional information of the slider 902. The shape of the boundary 903 may be changed based on further user input after the positional information of the boundary 903 is determined.

The boundary 903 passing through a certain pixel of the input image display area 900 can be acquired by specifying the certain pixel by user input (for example, click, touch, etc.), instead of using the slide bar 901 and the slider 902.

The GUI of FIG. 26 includes an input image display area 1000, a slide bar 1001, a slider 1002 and a boundary 1003. In the input image display area 1000, the input image 10 itself or the input image 10 which has been reduced or enlarged or subjected to color space conversion may be displayed.

The slider 1002 moves along the slide bar 1001 in accordance with user input (for example, click, touch, drag, etc.). Positional information of the slider 1002 is associated with positional information of the boundary 1003. Accordingly, the area information acquisition unit 201 can acquire the positional information of the boundary 1003 based on the positional information of the slider 1002. The boundary 1003 is a straight line or a curve connecting pixels having the depth (or the transmittance) designated in the input image 10, and the designated depth (or transmittance) is uniquely determined by the positional information of the slider 1002. The shape of the boundary 1003 may be changed based on further user input after the positional information of the boundary 1003 is determined.

The boundary 1003 passing through a certain pixel of the input image display area 1000 can be acquired by specifying the certain pixel by user input (for example, click, touch, etc.), instead of using the slide bar 1001 and the slider 1002.

The area information 20 may include an index allocated to each area to easily differentiate areas. The index may be allocated by user input or automatically allocated by the area information acquisition unit 201. For example, in the case where the indices are allocated in the form of successive numbers, if a user selects areas one by one, numbers will be sequentially allocated to the areas in the user-selected order. In FIG. 11, indices R having sequential numbers are allocated.

The user may select areas randomly, from those having longer distance between a view point and an object within the area (a close view to a distant view), or from those having shorter distance between a view point and an object within the area (a distant view to a close view).

In step S202, the area control information acquisition unit 211 acquires a set of area control information 21 corresponding to the plurality of areas based on the area information 20, and the integration unit 212 integrates the set of area control information 21 to generate the control information 22.

The area control information acquisition unit 211 may acquire the area control information 21 for each area by the processing same as or similar to that of the control information acquisition unit 102. Alternatively, the area control information acquisition unit 211 may acquire the area control information 21 for part of areas and calculate the area control information 21 for the other areas based on the acquired area control information 21.

For example, since the transmittance becomes low as the distance between a view point and an object in an area (i.e., depth) increases, the area control information acquisition unit 211 may calculate the area control information 21 in accordance with the depth. That is, the area control information acquisition unit 211 may acquire the area control information 21 of an area A, and then calculate the area control information 21 of an area B in accordance with the difference in depth between areas A and B, based on the above characteristics of the transmittance.

For example, it is assumed that the input image 10 is divided into three areas Ω₁, Ω₂ and Ω₃, area control information r₁ is acquired for area Ω₁, area control information r₂ is acquired for area Ω₂, and area control information r₃ is acquired for area Ω₃. In this case, the integration unit 212 integrates area control information r₁, r₂ and r₃ into control information r(x) by

$$r ( x ) = \{ \begin{matrix}{r}_{1} & if & x ∈ {Ω}_{1} \\ {r}_{2} & else if & x ∈ {Ω}_{2} \\ {r}_{3} & otherwise & x ∈ {Ω}_{3}\end{matrix} \qquad ( 15 )$$

Alternatively, the integration unit 212 may acquire the control information 22 in the form of a control information map illustrated in FIG. 12. In the control information map, the positions of pixels are associated with the control information 22.

As explained above, the image processing apparatus according to the second embodiment divides an input image into a plurality of areas, acquires area control information relative to each area, and adjusts the amount of scattered light included in each pixel based on the area control information to generate an output image. With this structure, the image processing apparatus can adjust the amount of scattered light for each area, not for the entire image. For example, it is possible to apply sophisticated image processing such as adding scattered light to a distant view area and eliminating scattered light from a close view area, thereby finely adjusting the depth feel of the output image.

### Third Embodiment

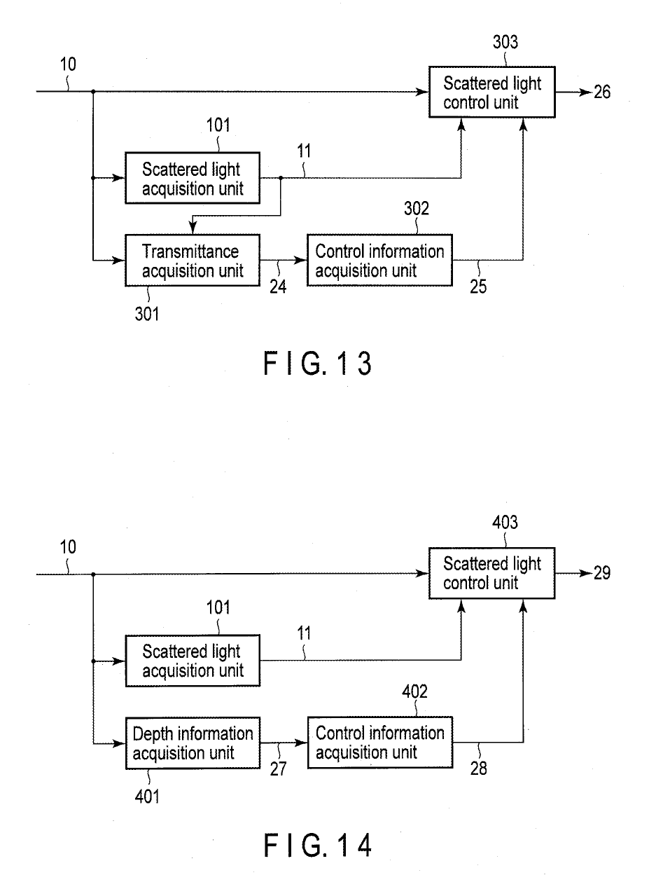

As illustrated in FIG. 13, an image processing apparatus according to the third embodiment comprises a scattered light acquisition unit 101, a transmittance acquisition unit 301, a control information acquisition unit 302, and a scattered light control unit 303. The image processing apparatus shown in FIG. 13 generates an output image 26 by controlling the amount of scattered light 11 included in each pixel of an input image 10 based on control information 25.

The transmittance acquisition unit 301 receives the input image 10, and inputs information of the scattered light 11 from the scattered light acquisition unit 101. The transmittance acquisition unit 301 typically acquires a transmittance 24 of each pixel in the input image 10 based on the input image 10 and the scattered light 11. The transmittance acquisition unit 301 can acquire the transmittance 24 of each pixel within a local area by analyzing a pixel value within the local area of the input image 10, for example. Alternatively, the transmittance acquisition unit 301 may acquire the transmittance 24 based on the depth of each pixel of the input image 10, as described below. In this case, the transmittance acquisition unit 301 does not have to input the information of the scattered light 11. The transmittance acquisition unit 301 outputs the information of the transmittance 24 to the control information acquisition unit 302.

The control information acquisition unit 302 input the information of the transmittance 24 from the transmittance acquisition unit 301. The control information acquisition unit 302 acquires the control information 25 associated with the transmittance 24. The control information acquisition unit 302 typically displays GUI described below on a display device not shown in the figures, acquires user input through the GUI, and acquires the control information 25 based on the user input. The control information acquisition unit 302 outputs the control information 25 to the scattered light control unit 303.

The scattered light control unit 303 receives the input image 10, inputs information of the scattered light 11 included in each pixel of the input image 10 from the scattered light acquisition unit 101, and inputs the control information 25 from the control information acquisition unit 302. The scattered light control unit 303 may further input information of the transmittance 24, if necessary. The scattered light control unit 303 generates the output image 26 by controlling the amount of the scattered light 11 included in each pixel of the input image 10 based on the control information 25.

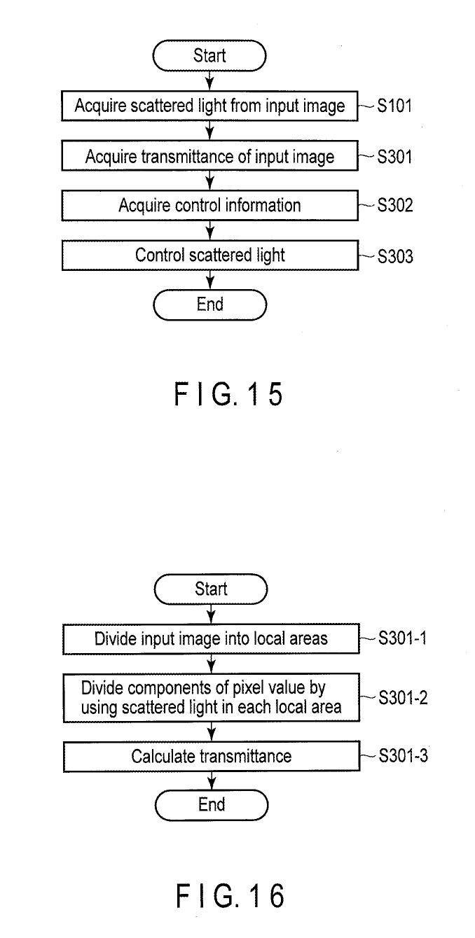

An example of image processing performed by the image processing apparatus shown in FIG. 13 will be described with reference to FIG. 15. When the image processing shown in FIG. 15 starts, the scattered light acquisition unit 101 acquires the scattered light 11 included in each pixel of the input image 10 (step S101). In FIG. 15, step S101 is the same as that shown in FIG. 2, and the detailed explanation will be omitted.

The transmittance acquisition unit 301 acquires the transmittance 24 of each pixel of the input image 10 (step S301). If the transmittance acquisition unit 301 acquires the transmittance 24 based on the scattered light 11, step S301 has to be carried out after step S101. However, if the transmittance acquisition unit 301 acquires the transmittance 24 without utilizing the scattered light 11 (for example, based on the depth), the order of performing steps may be different from that shown in FIG. 15 since step S101, and steps S301 and S302 are independent.

The control information acquisition unit 302 acquires the control information 25 associated with the transmittance 24 acquired in step S301 (step S302). The scattered light control unit 303 generates the output image 26 by controlling the amount of the scattered light 11 included in each pixel of the input image 10 acquired in step S101 based on the control information 25 acquired in step S302 (step S303).

Step S301 is shown in FIG. 16 in detail. The transmittance acquisition unit 301 divides the input image 10 into a plurality of local areas (steps S301-1). The local areas can be obtained by the method same as or similar to that for obtaining the first pixel areas 14.

The transmittance acquisition unit 301 divides the pixel value within each local area into a component in the same direction as the scattered light 11 and a component in the direction orthogonal to the scattered light 11 (step S301-2). The transmittance acquisition unit 301 divides the components of pixel value, for example, by:

$${I}_{A} ( x ) = \frac{〈 I ( x ) , A 〉}{‖ A ‖} \qquad ( 16 )$$

and

I_{R}′(x)=\sqrt{∥I(x)∥²−I_{A}(x)²} (17)

In Equation (17), I_{A}(x) denotes a component in the same direction as the scattered light 11 among pixel value I(x), and I_{R}′(x) denotes a component in the direction orthogonal to the scattered light 11 among pixel value I(x).

The transmittance acquisition unit 301 calculates the transmittance 24 by using the components divided in step S301-2 (step S301-3). The transmittance acquisition unit 301 calculates the transmittance 24, for example, by:

$$t ( x ) = \frac{1 - ( {I}_{A} ( x ) - η ( x ) {I}_{{R}^{′}} ( x ) )}{‖ A ‖} \qquad ( 18 )$$

where η(x) is a variable representing the ratio of a component in the same direction as the scattered light 11 to a component in the direction orthogonal to the scattered light 11 among reflected light vector J(x) in pixel x. By using η(x), it is possible to divide the component in the same direction as the scattered light 11 of the pixel value I(x) into a component (η(x)I_{R}(x)) caused by J(x) and a component (I_{A}(x)−η(x)I_{R}(x)) caused by the scattered light 11. η(x) is given by:

$$η ( x ) = \frac{{C}_{{Ω}^{′}} ( {I}_{A} , h )}{{C}_{{Ω}^{′}} ( {I}_{{R}^{′}} , h )} \qquad ( 19 )$$

where Ω′ denotes a local area including pixel x and peripheral pixels, and c_{Ω}′(a(x), b(x)) denotes covariance of variables a(x) and b(x). h(x) is given by:

$$h ( x ) = \frac{‖ A ‖ - {I}_{A} ( x )}{{I}_{{R}^{′}} ( x )} \qquad ( 20 )$$

Alternatively, since the depth and the transmittance are correlated with each other, the transmittance acquisition unit 301 may acquires the transmittance 24 by using the correlation. Concretely, the transmittance 24 may be calculated based on the depth by:

t(x)=e^{-βd(x)} (21)

Using Equation (21) decrease the amount of calculation for the transmittance 24.

In Equation (21), d(x) denotes the depth in pixel x. That is, the distance between a view point and an object indicated by pixel x increases as d(x) becomes large. The value d(x) may be acquired based on user input or automatically acquired through analysis of the input image 10. In addition, β is an integer indicating the scattering of light in each unit distance, and may be determined in accordance with the circumstances where the input image 10 has been captured. For example, β may be set to a small value for the input image 10 captured in clear air, and may be set to a large value for the input image 10 captured in not clear air.

Depth d(x) or transmittance t(x) may be acquired by:

$${I}^{dark} ( x ) = {min}_{c ∈ \{ r , g , b \}} ( {min}_{y ∈ S ( x )} ( {I}^{C} ( y ) ) ) \qquad ( 22 )$$

In Equation (22), r value of I(x) is substituted for I^{r}, g value of I(x) is substituted for I^{g}, and b value of I(x) is substituted for I^{b}. S(x) is a local area whose center is pixel x. According to the related art, “Single Image Haze Removal Using Dark Channel Prior (2009),” I^{dark}(x)) increases as the ratio of scattered light mixed in pixel x is high, and I^{dark}(x) decreases as the ratio of scattered light mixed in pixel x is low.

Accordingly, transmittance t(x) can be derived by Equation (21) in which I^{dark}(x) or a value obtained by performing a certain calculation to I^{dark}(x) is used as aforementioned depth of d(x). In addition, although transmittance t(x) can be derived directly by I^{dark}(x), it is necessary to at least normalize I^{dark}(x) to obtain transmittance t(x) which is not less than 0 and not greater than 1.

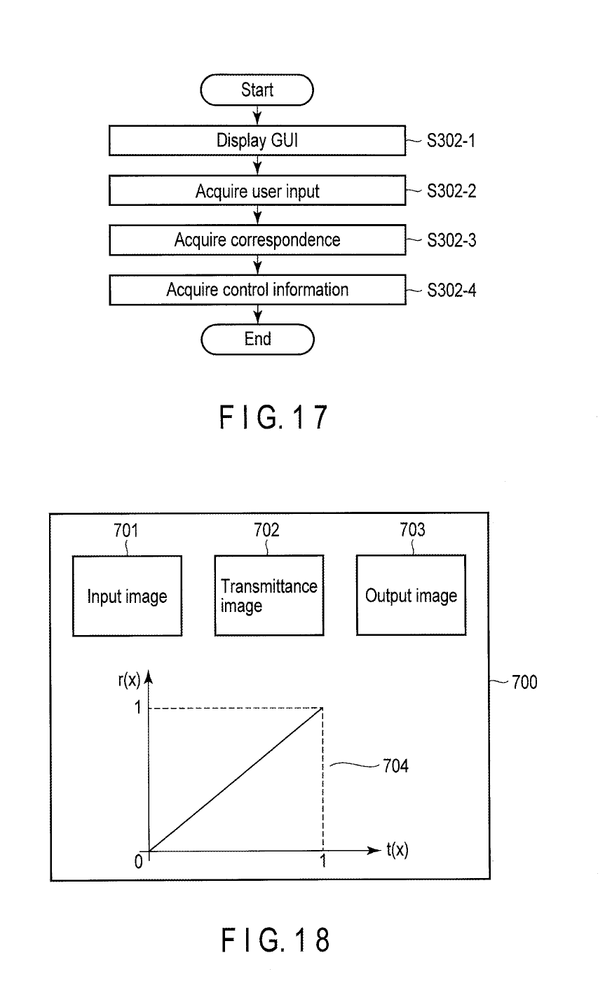

Step S302 is shown in FIG. 17 in detail. The control information acquisition unit 302 displays a GUI on a display device not shown in the figures (steps S302-1). The control information acquisition unit 302 acquires user input through the GUI displayed in step S302-1 (steps S302-2). The control information acquisition unit 302 acquires correspondence between the transmittance 24 and the control information 25 based on the user input acquired in step S302-2 (step S302-3). The control information acquisition unit 302 acquires the control information 25 based on the transmittance 24 and the correspondence acquired in step S302-3 (step S302-4).

In step S302-1, the control information acquisition unit 302 may display GUI 700 shown in FIG. 18. The GUI 700 includes an input image display area 701, a transmittance image display area 702, an output image display area 703, and a correspondence display area 704. In the input image display area 701, the input image 10 itself or the input image 10 which has been reduced or enlarged or subjected to color space conversion may be displayed.

In the transmittance image display area 702, a transmittance image indicating the transmittance 24 for each pixel of the input image 10 is displayed. The transmittance image may be an image generated by converting the transmittance 24 of each pixel of the input image 10 into a gray-scale value. Displaying the transmittance image allows the user to visually recognize the distribution of transmittance of the input image 10 when finely adjusting the control information 25.

In the output image display area 703, the output image 26 itself generated based on the provisional value of the control information 25 corresponding to the current user input or the output image 26 which has been reduced or enlarged or subjected to color space conversion may be displayed. The output image 26 may be generated by the scattered light control unit 303 based on the provisional value of the control information 25 and supplied to the control information acquisition unit 302, or directly generated by the control information acquisition unit 302 based on the provisional value. Providing the input image display area 701 and the output image display area 703 in a single interface allows the user to finely adjust the control information 25 while easily checking the final output image 26.

The correspondence display area 704 displays the correspondence between the transmittance 24 and the control information 25. FIG. 18 shows the correspondence indicated by r(x)=t(x). As described below, the correspondence varies in accordance with user input acquired in step S302-2.

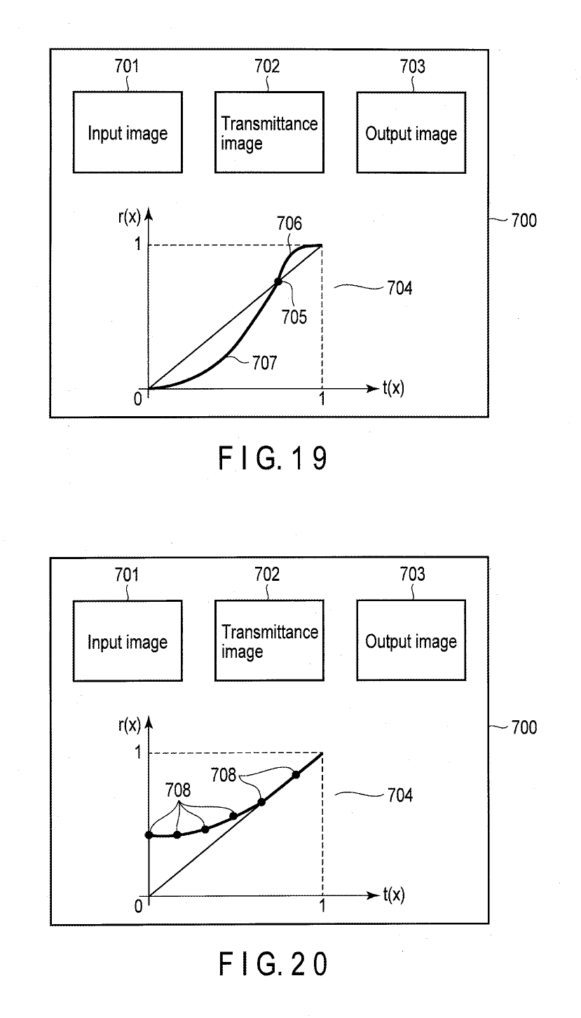

For example, as shown in FIG. 19, when user input (for example, click, touch, etc.) for selecting a point on a line indicating the correspondence is acquired, the point may be set as an inflection point 705. The correspondence at the right side from the inflection point 705 is set by a curve 706, and the correspondence at the left side from the inflection point 705 is set by a curve 707. The characteristics of the curves 706 and 707 may be determined automatically or based on user input. Two or more inflection points can be set.

For example, as shown in FIG. 20, when user input (for example, click, touch, etc.) for setting one or more point is acquired, the correspondence may be determined by a curve or a straight line passing through a set point 708. In this case, the curve or straight line indicating the correspondence can be acquired by interpolating the set point 708, for example, by using a spline function.

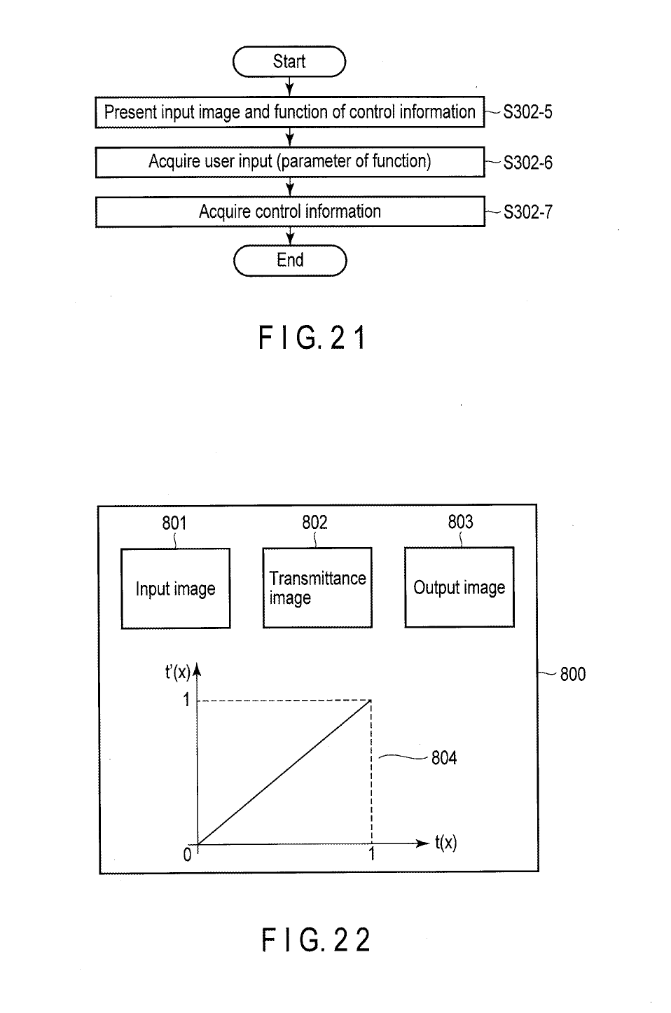

Alternatively, step S302 may be performed as shown in FIG. 21, instead of FIG. 17. According to FIG. 21, the control information acquisition unit 302 presents the input image 10 and a function determining the correspondence between the transmittance 24 and the control information 25 to the user through the GUI, for example (steps S302-5). The function may be a quadratic equation (23) below.

r(x)=f(t(x))=a(t(x))²+bt(x)+c (23)

The control information acquisition unit 302 may present a graph of the function when default parameters are set or an equation specifying a function to the user.

The control information acquisition unit 302 acquires user input designating a parameter of a function (step S302-6). For example, if the function is Equation (23), the parameters to be designated are part of or all of coefficients a, b and c. The user input in step S302-6 may be directly designating a parameter of the function through a box, or a modifying operation such as dragging relative to the presented graph.

The control information acquisition unit 302 acquires the control information 25 by determining the function based on the user input acquired in step S302-6 (step S302-7).

The control information 25 may be calculated based on the correspondence between the transmittance t(x) of each pixel of the input image 10 and the transmittance t′(x) of the corresponding pixel of the output image 26 acquired based on the user input and Equation (13).

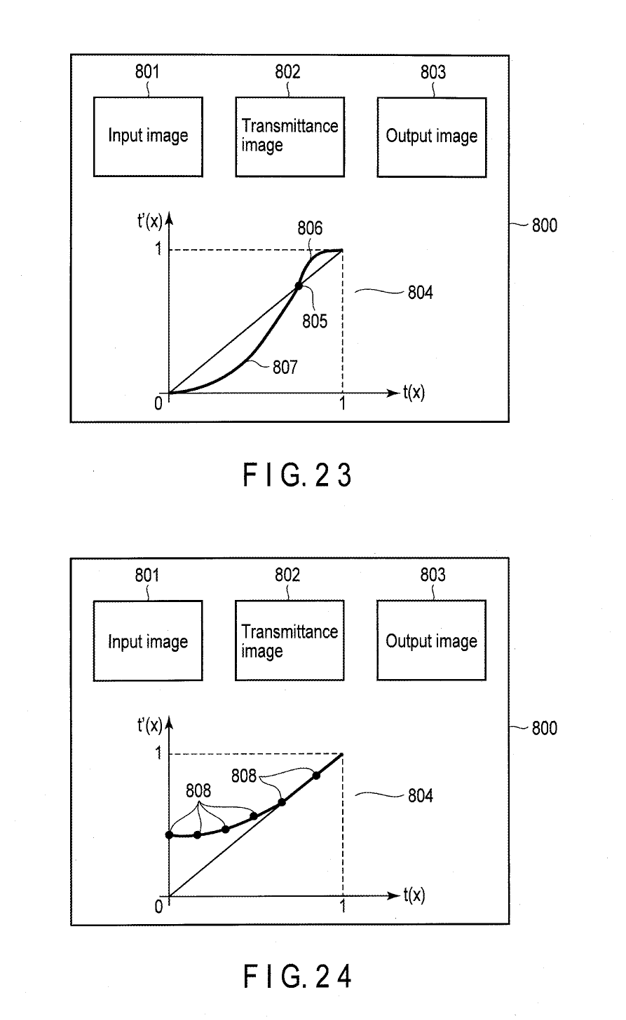

In this case, the GUI 700 shown in FIGS. 18, 19 and 20 may be modified as a GUI 800 shown in FIGS. 22, 23 and 24. An input image display area 801, a transmittance image display area 802, an output image display area 803, a correspondence display area 804, an inflection point 805, a curve 806, a curve 807 and a set point 808 shown in FIGS. 22, 23 and 24 correspond to the input image display area 701, the transmittance image display area 702, the output image display area 703, the correspondence display area 704, the inflection point 705, the curve 706, the curve 707 and the set point 708 shown in FIGS. 18, 19 and 20, respectively.

Unlike the correspondence display area 704, in the correspondence display area 804, the correspondence between the transmittance t(x) and the transmittance t′(x) is displayed, and the correspondence varies according to the user input. The control information 25 is calculated based on the correspondence and Equation (13).

The transmittance t′(x) of each pixel of the output image 26 can be acquired by acquiring parameters of a function corresponding to the user input. In this case, the control information acquisition unit 302 may operate as shown in FIG. 21. However, since the function expresses the correspondence between the transmittance t(x) and the transmittance t′(x), it should be replaced with:

t′(x)=f(t(x))=a(t(x))²+bt(x)+c (24)

As explained above, the image processing apparatus according to the third embodiment acquires control information having correspondence with the transmittance, and adjusts the amount of scattered light included in each pixel based on the control information to generate an output image. With this structure, the image processing apparatus can designate the control information in detail. That is, the image processing apparatus can finely adjust the depth feel of the output image.

If control information indicating that the magnitude relation of transmittance between any two pixels of the output image is opposite to that between the corresponding pixels in the input image is acquired, a viewer may feel wrongness since the depth of the output image is reversed. Thus, it is desirable to acquire control information in which the magnitude relation of transmittance between two pixels of the output image is the same as that between the corresponding pixels in the input image.

The present embodiment may be combined with the second embodiment. For example, step S302 shown in FIG. 15 can be performed for each of a plurality of areas obtained by dividing the input image 10.

As stated above, the depth and the transmittance have correlation. Thus, the present embodiment can be modified to use control information having the correspondence with the depth not with the transmittance. The image processing apparatus shown in FIG. 14 comprises the scattered light acquisition unit 101, a depth information acquisition unit 401, a control information acquisition unit 402, and a scattered light control unit 403.

The depth information acquisition unit 401 receives the input image 10. The depth information acquisition unit 401 may acquire the depth 27 of each pixel of the input image 10 based on user input or automatically through analysis of the input image 10. The depth information acquisition unit 401 output information of the depth 27 to the control information acquisition unit 402.

The control information acquisition unit 402 input the information of the depth 27 from the depth information acquisition unit 401. The control information acquisition unit 402 acquire control information 28 having the correspondence with the depth 27. The control information acquisition unit 402 can acquire the control information 28 through the processing similar to that performed in the control information acquisition unit 302. Concretely, the processing performed by the control information acquisition unit 402 is the same as that performed by the control information acquisition unit 302 except that the transmittance 24 is replaced with the depth 27, and the control information 25 is replaced with the control information 28. The control information acquisition unit 402 outputs the control information 28 to the scattered light control unit 403.

The scattered light control unit 403 receives the input image 10, inputs information of the scattered light 11 included in each pixel of the input image 10 from the scattered light acquisition unit 101, and inputs the control information 28 from the control information acquisition unit 402. The scattered light control unit 403 may further input information of the depth 27, for example, if required. The scattered light control unit 403 controls the amount of the scattered light 11 included in each pixel of the input image 10 based on the control information 28 to generate an output image 29.

Further, control information having the correspondence with a parameter different from the transmittance or the depth (for example, the position of pixel) can be used. For example, control information such as r(x) and t′(x) may be directly set to each pixel.

### Fourth Embodiment

Part of or all of various information explained in the first to third embodiments can be automatically acquired, not based on user input.

For example, the control information acquisition unit 102 and the control information acquisition unit 210 may acquire predetermined values as the control information 12 and the control information 22. The control information acquisition unit 302 and the control information acquisition unit 402 may acquire the control information 25 and the control information 28 based on the predetermined correspondence.

In addition, the area information acquisition unit 201 may prepare the area information 20 or acquire the area information 20 by performing threshold processing to the depth or transmittance in each pixel of the input image 10. For example, the area information acquisition unit 201 may acquire the area information 20 that specifies an area formed of a pixel having the depth less than a certain threshold and an area formed of a pixel having the depth greater than or equal to the threshold.

As explained above, the image processing apparatus according to the fourth embodiment automatically, not based on user input, acquires part of or all of information acquired in the image processing apparatus according to the first to third embodiment based on user input. With this structure, the image processing apparatus can adjust the depth feel of the output image while reducing the user's input load.

The processing in the above-described embodiments can be implemented using a general-purpose computer as basic hardware. For example, a general-purpose computer shown in FIG. 27 may be used. The general-purpose computer includes a central processing unit (CPU), a main storage, an auxiliary storage, a communication interface (IF) and a bus. The CPU controls the whole computer. The main storage may include a read only memory (ROM) or random access memory (RAM) for storing data and a program. The auxiliary storage may include hard disk drive (HDD) for storing data and a program. The communication IF controls communication with an external device. The CPU, main storage, auxiliary storage and communication IF are connected via the bus for exchanging data.

A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing apparatus, comprising:
a scattered light acquisition unit configured to acquire an amount of scattered light included in each pixel of an input image;
a control information acquisition unit configured to acquire control information determining an amount of scattered light included in each pixel of an output image; and
a control unit configured to generate the output image by controlling the amount of the scattered light included in each pixel of the input image based on the control information.

2. The apparatus according to claim 1, wherein the control information acquisition unit acquires the control information based on user input.

3. The apparatus according to claim 2, further comprising a transmittance acquisition unit configured to acquire information of transmittance in each pixel of the input image, wherein the control information acquisition unit acquires correspondence between the transmittance and the control information based on user input, and acquires the control information based on the transmittance and the correspondence.

4. The apparatus according to claim 2, further comprising a depth acquisition unit configured to acquire information of depth in each pixel of the input image, wherein the control information acquisition unit acquires correspondence between the depth and the control information based on user input, and acquires the control information based on the depth and the correspondence.

5. The apparatus according to claim 2, further comprising an area information acquisition unit configured to acquire area information specifying a plurality of areas obtained by dividing the input image, wherein the control information acquisition unit acquires control information for each of the plurality of areas based on the area information and user input.

6. The apparatus according to claim 5, wherein the area information acquisition unit acquires the area information based on user input.

7. The apparatus according to claim 5, wherein the area information acquisition unit acquires the area information by performing threshold processing to depth in each pixel of the input image.

8. The apparatus according to claim 1, further comprising a transmittance acquisition unit configured to acquire information of transmittance in each pixel of the input image, wherein the control information acquisition unit acquires correspondence between the transmittance and the control information, and acquires the control information based on the transmittance and the correspondence.

9. The apparatus according to claim 1, further comprising a depth acquisition unit configured to acquire information of depth in each pixel of the input image, wherein the control information acquisition unit acquires correspondence between the depth and the control information, and acquires the control information based on the depth and the correspondence.

10. The apparatus according to claim 1, wherein magnitude relation of transmittance between arbitrary two pixels of the output image is not opposite to magnitude relation of transmittance between corresponding two pixels of the input image.

11. The apparatus according to claim 1, wherein the control information is a ratio of transmittance in each pixel of the output image to transmittance in corresponding pixel of the input image.

12. The apparatus according to claim 3, wherein the transmittance acquisition unit acquires information of depth in each pixel of the input image and calculates the transmittance based on the depth.

13. An image processing method, comprising:
acquiring an amount of scattered light included in each pixel of an input image;
acquiring control information determining an amount of scattered light included in each pixel of an output image; and
generating the output image by controlling the amount of the scattered light included in each pixel of the input image based on the control information.
